(19) United States
(12) Patent Application Publication
(10) Pub. No.: US 2006/0253807 A1
(43) Pub. Date: Nov. 9, 2006

(54) Recording medium and data processing device

(76) Inventors: Hirokazu So, Osaka (JP); Takuji Maeda, Osaka (JP); Shinji Inoue, Osaka (JP); Makoto Ochi, Osaka (JP); Masato Suto, Osaka (JP); Kazuya Fujimura, Nara (JP); Yukiko Inoue, Osaka (JP)

Correspondence Address: SMITH PATENT OFFICE, 1901 PENNSYLVANIA AVENUE N W, SUITE 901, WASHINGTON, DC, 20006, US

(21) Appl. No.: 11/396,953

(22) Filed: Apr. 4, 2006

(30) Foreign Application Priority Data
Apr. 5, 2005 (JP) 2005-108364

(51) Int. Cl. G06F 17/50

(52) U.S. Cl. 716/1

(57) ABSTRACT

While reproducing content stored in a recording medium, a user terminal as a data processing device downloads a related content as different content related to the reproduction target content from a content distribution server via a communication network. Immediately after the reproduction of the reproduction target content is completed, a notification prompting reproduction or purchase of the related content is provided. This permits immediate reproduction of the related content when the user purchases it, which reduces the user's waiting time, thus improving purchase motivation for the related content.

### BACKGROUND OF THE INVENTION

1. Field of the Invention

The present invention relates to a recording medium for storing digitized contents, such as music, video, books, and the like, and to a data processing device for recording and reproducing contents.

2. Discussion of the Related Art

Recording media that record various digital data, such as music content, video content, still image content, and the like (hereinafter, referred to as contents) include various types of media, such as semiconductor recording media, magnetic discs, optical discs, magneto optical disks, and the like.

Of these media, the semiconductor recording media in particular have advantage in their compactness and lightweight, and also have been recently under rapid development toward larger capacity, higher rate, and lower price. They are now applicable to various appliances including digital cameras, cellular phones, portable music players, televisions, DVD recorders. Typical semiconductor recording media include an SD (secure digital) memory card, Memory Stick (registered trademark), Compact Flash (registered trademark), and the like.

Then, of these media, the SD memory card and the like whose market share has been rapidly increasing is provided with a copyright protection function. This copyright protection function permits preventing copyrighted content from unauthorized copying and thus permits the copyrighted content to be securely recorded and reproduced.

One example of a content storage method realized in a semiconductor recording medium having a copyright protection function is as described below.

The semiconductor recording medium is provided with a protected region to which a host appliance (reproducer, recorder or the like) is not accessible until mutual validity between the semiconductor recording medium and the host appliance is certified; and an ordinary region to which the host appliance is freely accessible. Then, content that is encrypted (hereinafter, referred to encrypted content) is recorded into the ordinary region, and a key for encrypting this content (hereinafter, referred to as a content key) is stored into the protected region. Content recorded by such a method can prohibit its reproduction in an unauthorized appliance that cannot certify mutual validity therewith, because the unauthorized appliance cannot read the content key and thus cannot decrypt the encrypted content. Further, even if only the encrypted content stored in the ordinary region is copied into another recording medium, the content key does not exist in the copy destination since an unauthorized appliance cannot copy the content key. Therefore, reproduction of the encrypted content that has been copied in an unauthorized manner is prohibited.

Conventionally, main contents to be stored into the semiconductor recording medium having a copyright protection function by such a storage method include music content ripped from a music CD (compact disc) the user purchased, and the like.

However, more and more applications to various contents by using the copyright protection function possessed by the semiconductor recording medium have been achieved in recent years.

For example, by using a personal computer (hereinafter, referred to as PC) connected to the Internet network or a cellular phone, copyrighted content, such as music, a book, or the like, is downloaded from a content provider through payment for a required price. Then, the downloaded content is recorded into the semiconductor recording medium, whereby the music content stored in the semiconductor recording medium can be enjoyed with a compact semiconductor player or a cellular phone terminal or the book content can be read.

In addition, not only from an Internet-connected PC and a cellular phone, but also from electronic terminals (KIOSK terminals) installed in specific places, such as a convenience store, designated shop, station, and the like, contents can be purchased. Since the development of these applications is greatly convenient for the user and also spreads out various sales networks for content providers, it is expected that various contents and usage environments will be increasingly wide spread in future. Japanese Unexamined Patent Publication No. 2004-94677 discloses a management unit, browsing device, program, and method for a content distribution system for more facilitated content distribution.

### SUMMARY OF THE INVENTION

However, to download content from a communication network, such as the Internet network or the like, and reproduce it, some fixed time is required until completion of this downloading. The download time becomes shorter with improvement in the transfer rate of the communication network, but content of a larger capacity and higher quality (a video, music, or the like of a high bit rate) requires a longer length of time.

The download time becomes a waiting time for the user; thus, a longer download time results in a decrease in the user's motivation for acquiring content, thus leading to a higher possibility of losing sales opportunities on the content provider side. On the contrary, degrading the content quality for reducing the waiting time also reduces the user's interest in the content, thus causing a similar problem.

For example, it is assumed that the user views content already stored in a recording medium with a data processing device and that the user is satisfied with the details of this content. And it is assumed that the user has a desire to view content sequel to this content (hereinafter, referred to as sequel content).

In this condition, if the user confirms the sequel content via the communication network, downloads the desired sequel content, and pays for the price of the sequel content, the user can view the sequel content. However, if the user cannot accept this waiting time, the content provider will lose sales opportunities.

In view of the problem described above, it is an object of the present invention to provide a recording medium, a data processing device, and a data processing system capable of easily obtaining content related to viewed content from the communication network.

To solve the problems, a recording medium of the present invention is a recording medium storing at least one content and information on said content, wherein the information on said content comprises: address information on a communication network required for acquiring information on related contents related to said content via the communication network; and timing information indicating timing for starting the acquisition of said information on said related contents via the communication network.

To solve the problems, a data processing device of the present invention is a data processing device to which a recording medium storing at least one content and information on said content is connected, wherein the data processing device comprises: a communication processor connecting to a communication network for downloading information on related contents related to said content and the related content into said recording medium; and a controller which controls to reproduce the content stored in said recording medium and to acquire the information on said related contents from said communication processor via said communication network before the reproduction of said content ends.

To solve the problems, a data processing device of the present invention is a data processing device to which a recording medium storing at least one content and information on the content is connected, wherein the data processing device comprises: a communication processor connecting to a communication network for downloading related content related to said content into said recording medium; and a controller which controls to reproduce the content stored in said recording medium and to acquire the related contents from said communication processor via said communication network before the reproduction of said content ends.

Said communication processor may determine timing for acquiring said related contents via said communication network, based on net information acquisition timing information stored in said recording medium.

Said related contents may be contents provided in series of said contents.

Said related contents may be contents having at least one attribute in common with said content.

Said controller may provide a notification prompting reproduction or purchase of said related contents immediately after the reproduction of the content ends.

Said recording medium may previously stores information on said related content.

Said related contents may be encrypted contents.

By using the recording medium, the data processing device, and the data processing system according to the present invention, while content is being reproduced, information on content related to the content under reproduction can easily be obtained and downloaded, and thus, the details of the related content can be confirmed, reproduced, or purchased immediately after the reproduction of the original content has ended. Accordingly, sales opportunities for the content provider increase.

### BRIEF DESCRIPTION OF THE DRAWINGS

FIG. 1 is a block diagram showing an example of the configuration of a content distribution system according to Embodiment 1 of the present invention;

FIG. 2 is a block diagram showing an example of the internal configuration of a user terminal according to Embodiment 1;

FIG. 3 is a block diagram showing an example of the internal configuration of a recording medium according to Embodiment 1;

FIG. 4 is a conceptual diagram showing an example of the data structure of the recording medium according to Embodiment 1;

FIG. 5 is a conceptual diagram showing one example of data stored in a content information DB of a content management server according to Embodiment 1;

FIG. 6 is a conceptual diagram showing one example of data stored in a purchase history DB of an accounting server according to Embodiment 1;

FIG. 7A is a conceptual diagram showing one example of procedures of content purchase and reproduction performed by a content distribution system as a precursor to Embodiment 1;

FIG. 7B is a conceptual diagram showing one example of the procedures of content purchase and reproduction performed by the content distribution system as the precursor to Embodiment 1;

FIG. 8A is a conceptual diagram showing one example of procedures of content purchase and reproduction performed by the content distribution system according to Embodiment 1;

FIG. 8B is a conceptual diagram showing one example of the procedures of content purchase and reproduction performed by the content distribution system according to Embodiment 1;

FIG. 9 is a conceptual diagram showing one example of a display screen of the user terminal according to Embodiment 1;

FIG. 10A is a flowchart showing one example of procedures of content acquisition, purchase, and reproduction by the user terminal according to Embodiment 1;

FIG. 10B is a flowchart showing one example of the procedures of content acquisition, purchase, and reproduction performed by the user terminal according to Embodiment 1;

FIG. 11 is a conceptual diagram showing an example of data structure of a recording medium according to another embodiment of the present invention; and

FIG. 12 is a conceptual diagram showing an example of data structure of a recording medium according to another embodiment of the present invention.

### DESCRIPTION OF THE PREFERRED EMBODYMENTS

### Embodiment 1

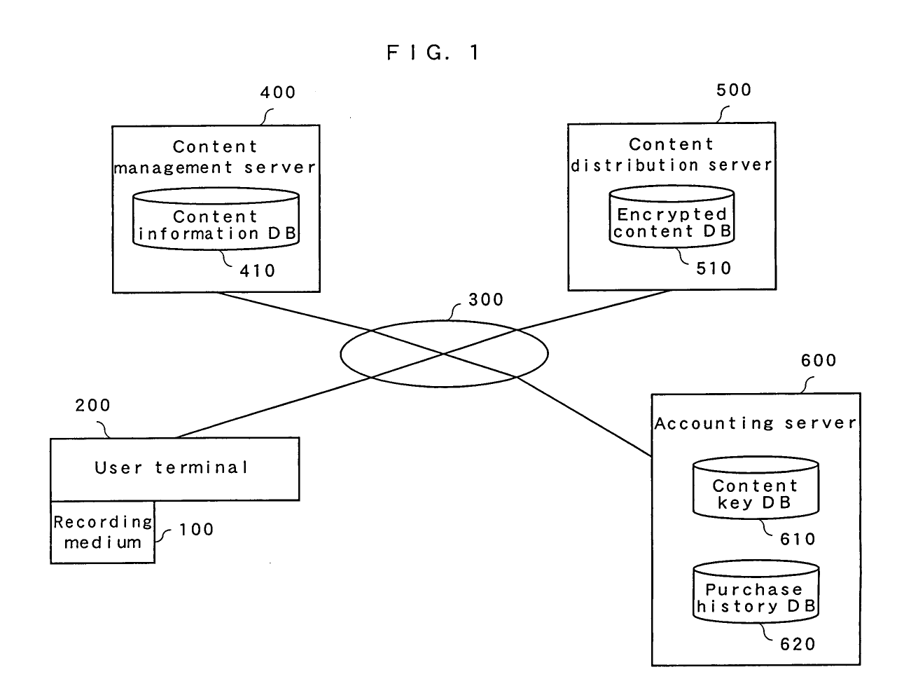

Hereinafter, Embodiment 1 of the present invention will be described in detail based on the accompanying drawings. FIG. 1 is a diagram showing the configuration of a content distribution system according to Embodiment 1 of the present invention. The content distribution system according to the present embodiment includes: user environment composed of a recording medium 100 and user terminal (data processing device) 200; a communication network 300, content management server 400, a content distribution server 500, and an accounting server 600.

The user terminal 200 is directly or indirectly connected via the communication network 300 to the content management server 400, the content distribution server 500, and the accounting server 600, and is capable of data transmission and reception. The user terminal 200 is provided for each user who uses this content distribution system.

In the user terminal 200, content is to be stored into the recording medium 100. The recording medium 100 is a storage medium capable of data reading and writing, and may be either removable from the user terminal 200 or built therein. The recording medium 100 corresponds to: for example, a semiconductor recording medium, hard disc, or the like, which is built in; or an optical disc such as a DVD, semiconductor memory card, or the like, which is freely removable.

The user terminal 200 is a data processing device that can be connected to the communication network 300, and corresponds to, for example, a PC, cellular phone, or the like. The user terminal 200 is provided with a function that stores content into the recording medium 100 and a function that reproduces content stored in the recording medium 100.

The communication network 300 is a network that directly or indirectly connects together the user terminal 200, content management server 400, content distribution server 500, and accounting server 600, and that corresponds to, for example, the Internet network, a telephone line network, or the like.

The content management server 400 is provided with a content information database (hereinafter, referred to as a content information DB) 410, and manages information on each content.

The content distribution server 500 is provided with an encrypted content database (hereinafter, referred to as an encrypted content DB) 510, and stores at least one encrypted content that is encrypted by a content key corresponding to respective content. The encrypted content DB 510 is provided with at least a function that identifies each encrypted content by a content ID.

The accounting server 600 is provided with a content key database (hereinafter, referred to as a content key DB) 610 and a purchase history database (hereinafter, referred to as a purchase history DB) 620. The content key DB 610 stores information and at least one content key that encrypts respective contents.

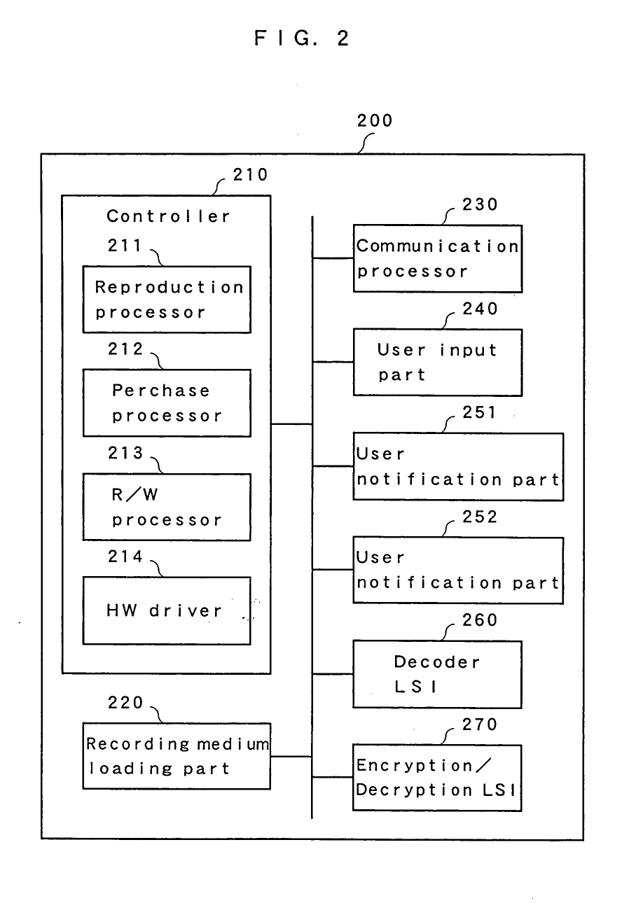

Next, the internal configuration of the user terminal 200 and the recording medium 100 composing the user environment will be described. FIG. 2 is a functional block diagram showing the internal configuration of the user terminal 200. The user terminal 200 includes a controller 210, recording medium loading part 220, communication processor 230, user input part 240, user notification parts 251 and 252, decoder LSI 260, and encryption/decryption LSI 270.

The controller 210 is a portion that controls operation of the user terminal 200. In the present embodiment, the controller 210 is provided with at least a function that performs a control required for the user terminal 200 to reproduce content stored in the recording medium 100 and a control required for the user terminal 200 to acquire information on the content and related content and then purchase the related content via the communication network 300. The controller 210 physically includes: a CPU, ROM for storing a program (software) for control, and RAM required for executing the program. The controller 210 functionally includes: a reproduction processor 211 that executes processing required for reproducing content, purchase processor 212 that executes processing required for purchasing content, R/W processor 213 that executes reading and writing from and into the recording medium 100, and HW driver 214 that controls hardware such as a decoder LSI 260, included in the user terminal 200.

The recording medium loading part 220 is a portion, for example a slot, in which the recording medium 100 is loaded, and the loading part 220 is provided with a function that accesses to the loaded recording medium 100.

The communication processor 230, which is connected to the communication network 300, is a portion that sends and receives data to and from various servers via the communication network 300, and corresponds to a modem in the present embodiment.

The user input part 240 is a portion that acquires information inputted by the user, and corresponds to a button and touch panel in the present embodiment.

The user notification parts 251 and 252 are portions that provide a notification to the user by an image and a sound, and respectively correspond to a liquid crystal display device and speaker in the present embodiment.

The decoder LSI 260 realizes decoding processing by hardware. Typically, content exists in an encrypted condition in order to reduce its size at the time of storage and at the time of transfer. In a case where content targeted for reproduction (hereinafter, referred to as reproduction target content) is in encrypted condition, the decoding processing is required at the time of reproduction. In the present embodiment, the decoding processing is executed by hardware (LSI). In a case where decoding is performed by software or a case where content is not in encoded condition, the decoder LSI 260 is not required.

The encryption/decryption LSI 270 realizes encryption processing and decryption processing by hardware. Typically, copyrighted content exists in a condition encrypted by the content key in order to prevent unauthorized copying. When the reproduction target content is in encrypted condition, decryption processing is required at the time of reproduction. And decrypted content may be subjected to encryption processing by another encryption method and then stored into the recording medium 100. In a case where the processing is performed by software or a case where content is not in encrypted condition, the encryption/decryption LSI 270 is not required.

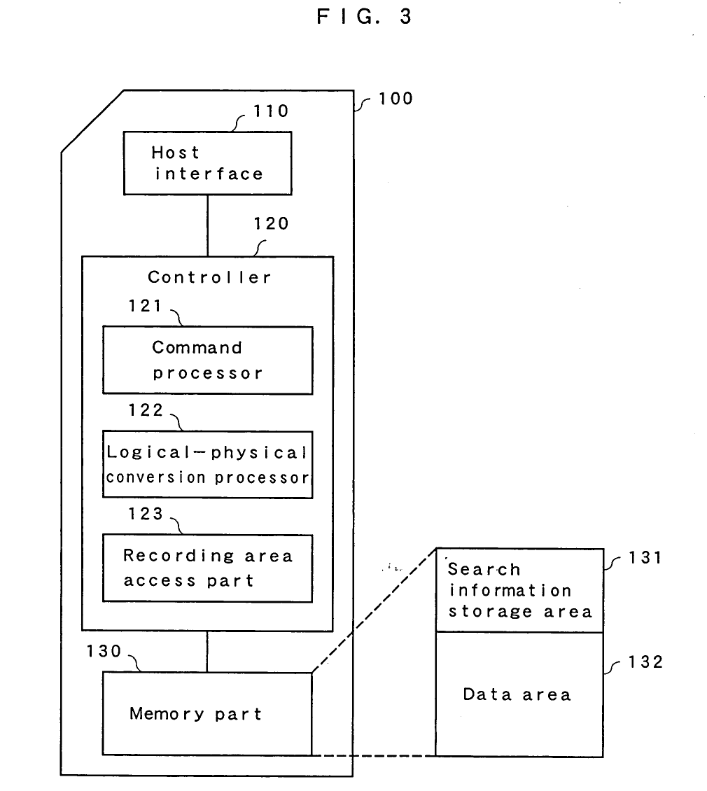

FIG. 3 is a diagram showing an example of the inner configuration of the recording medium 100 according to the present embodiment. The recording medium 100 includes a host interface 110, controller 120, and memory part 130. The host interface 110 is provided with a function that sends and receives data to and from the user terminal 200 as a host appliance of the recording medium 100.

The controller 120, which is provided with a function that performs internal control of the recording medium 100, interprets read and write commands received from the user terminal 200 and accesses to the memory part 130. The controller 120 also performs, as appropriate, processing of notifying the results to the user terminal 200 via the host interface part 110. The controller 120 physically includes: a CPU, ROM for storing a program (software) for control, and RAM required for executing the program. The controller 120 functionally includes: a command processor 121 that interprets and executes a command from the user terminal 200, a logical-physical conversion processor 122 that converts a logical address specified by the user terminal 200 during data reading or writing into a physical address in the memory part 130, and an recording area access part 123 that accesses to the memory part 130.

The memory part 130, which is provided with a function that stores data, is composed of a non-volatile memory, such as a flash memory or the like, in the present embodiment. In addition, the memory part 130 is provided with a search information storage area 131 and a data area 132. The data area 132 is an area that stores arbitrary data. The search information storage area 131 is an area that stores information (an address, a size, and the like) required for the user terminal 200 to extract each data stored in the data area 132. In the present embodiment, each data is managed by a FAT file system, and an area storing information required in the FAT file system (file system management information) corresponds to the search information storage area 131. Therefore, it is possible to access, as a file, data stored in the recording medium 100.

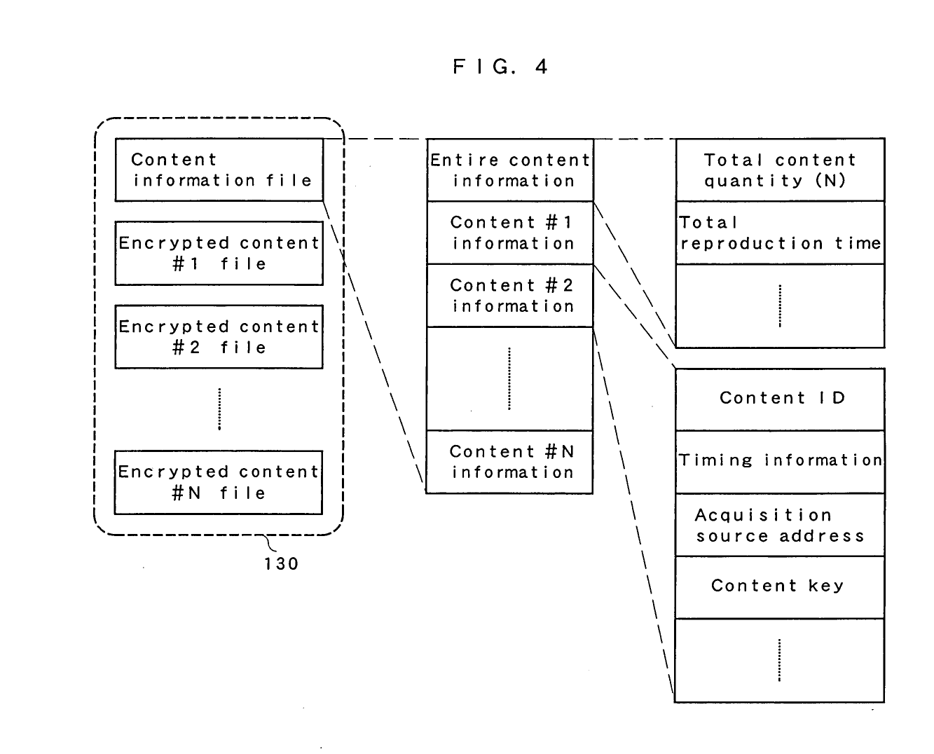

Next, referring to FIG. 4, a content storage method according to the present embodiment will be described. In FIG. 4, the memory part 130 stores N pieces of content in an encrypted condition as individual files, that is, encrypted content #1 file, encrypted content #2 file, . . . and encrypted content #N file.

Moreover, the memory part 130 stores, as a content information file, information on each encrypted content files. The content information file stores: entire content information on the entire N pieces of content stored in the memory part 130; and information on each of the N pieces of content, that is, content #1 information, content #2 information, . . . , and content #N information.

This entire content information includes: for example, a total content quantity (=N) indicating the number of contents stored in the memory part 130; total reproduction time, i.e., time required to reproduce all the contents stored in the memory part 130; play list describing the order in which the contents are reproduced; information indicating the content reproduced last time, and the like.

The content #i information (where i is a natural number smaller than or equal to N) includes: for example, a content ID, timing information describing timing at which information on a corresponding content is acquired via the communication network 300, an acquisition source address (URL or the like) for acquiring the information on the corresponding content via the communication network 300, the content key for decrypting the corresponding content, and the like.

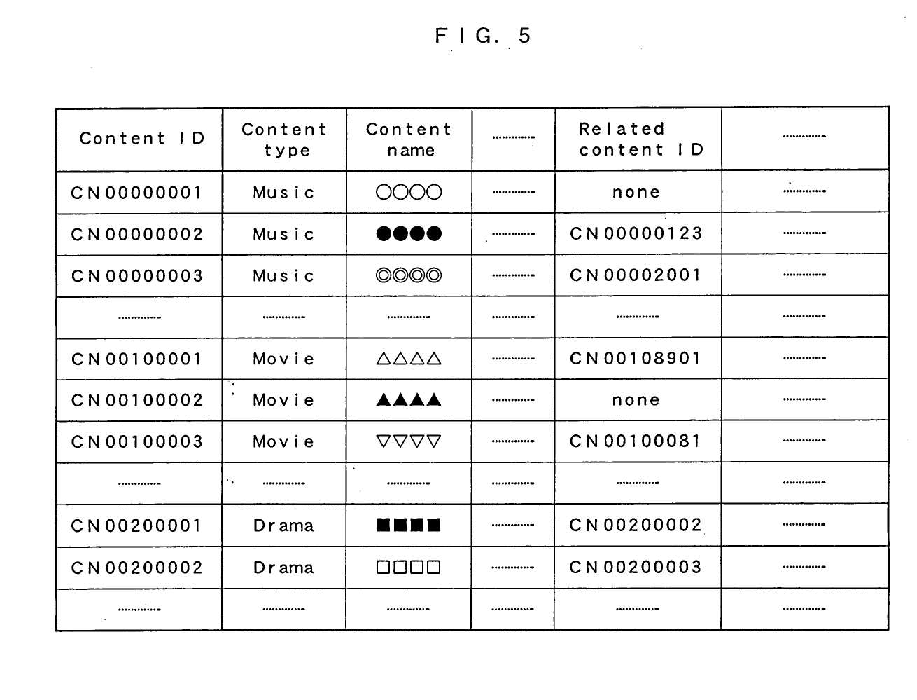

Next, the content information DB 410 provided in the content management server 400 will be described. FIG. 5 shows one example of this DB 410. Information on the contents stored in this DB 410 includes: for example, a content ID as a value uniquely provided to respective contents for content identification; a content type for identification of the type (music, movie, drama, book, still image, or the like) of the corresponding content; a content name as the name of the corresponding content; a related content ID as a content ID of content related to the corresponding content, and the like. In correspondence with the respective content IDs, the content types, content names, and related content IDs are stored. A thumbnail may be included which indicates the details of contents. In the present invention, the related content IDs, in particular, are important.

The related content is content related to respective contents, detailed examples of which are indicated below.

(1) Contents other than corresponding content in a content group provided in series, such as drama, strip cartoon, or the like, especially contents following the corresponding content (the sequel content described above and preceding content).

(2) Contents having some attribute in common with the corresponding content, for example, latest music contents created by the same artist, famous movie contents created by the same director, book contents sold as a best-seller by the same publisher, music contents in the same genre, drama contents in which the same actor plays the leading role, content occupying a large portion of those different contents purchased by the user who has purchased the corresponding content, or content belonging to the same group as the corresponding content. For example, there are content other than the corresponding content in a musical composition group provided as an album.

In a case where related content does not exist, a value denoting that the related content ID is invalid is to be stored. For the corresponding content, one or a plurality of related contents may exist. In a case where a plurality of related contents exists, it is desirable that priority levels are determined for the respective related contents.

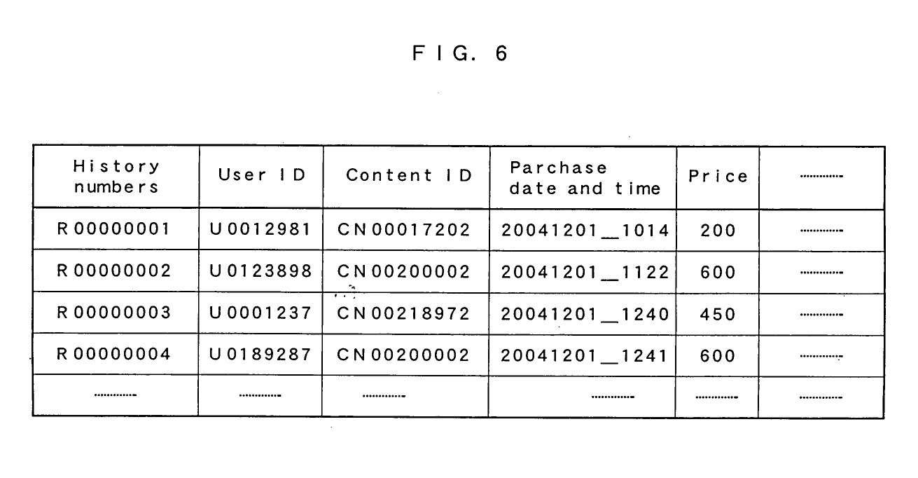

Next, a purchase history DB 620 included in the accounting server 600 will be described referring to FIG. 6. This DB 620 stores information required for charging the price of content purchased by the user. FIG. 6 shows an example of data stored in the DB 620, including data, such as history numbers as history identifiers, user IDs as user identifiers, content IDs of contents purchased by the users, purchase dates and times, purchase prices, and the like. In the content key DB 610, at least a function which identifies, by the content ID, a content key for decrypting encrypted content is provided.

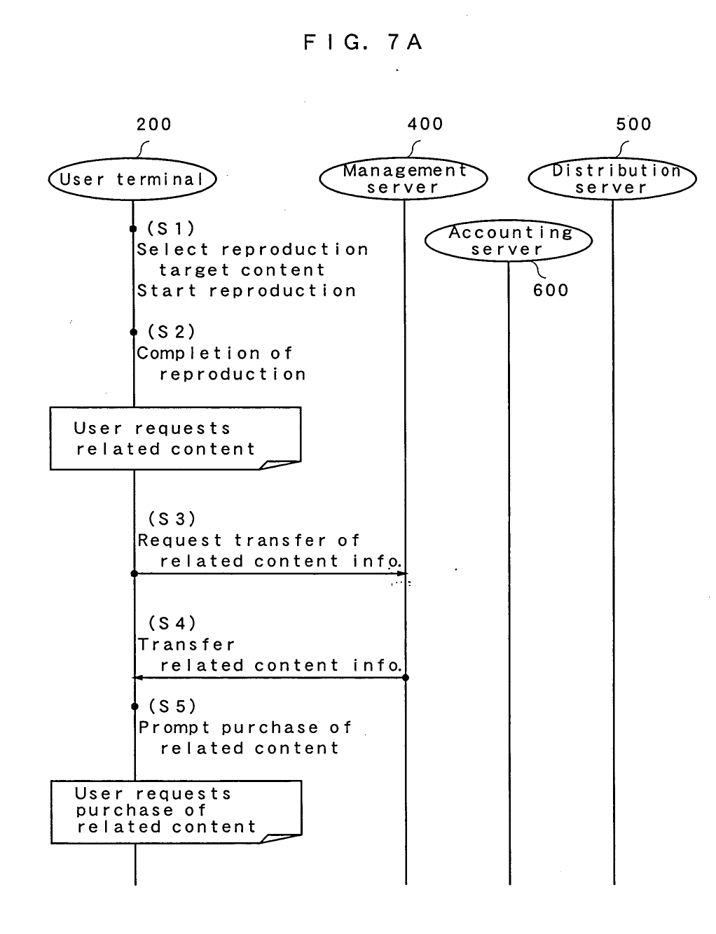

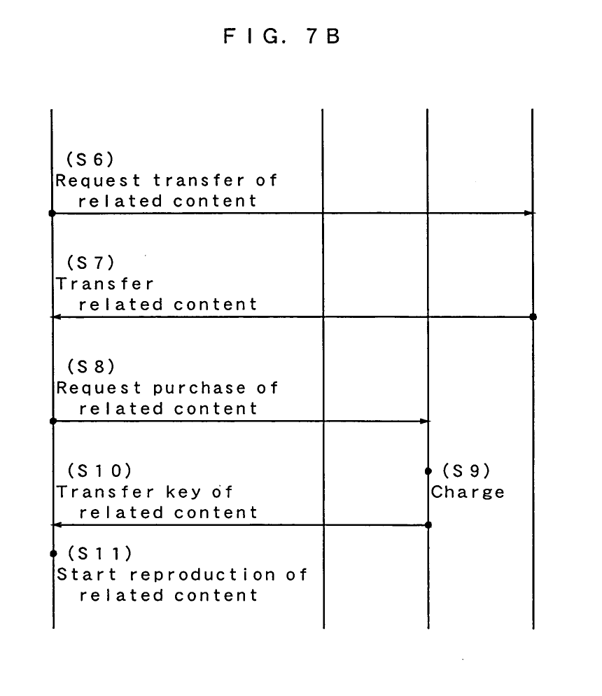

Hereinafter, a series of operation from purchase to reproduction performed in the content distribution system of the present embodiment will be described. First, referring to FIGS. 7A and 7B, operation performed by a content distribution system as a precursor to the present embodiment will be described. In the recording medium loading part 220 of the user terminal 200, the recording medium 100 is loaded, in which the N pieces of content have already been stored in the form shown in FIG. 4. The user terminal 200 notifies, via the notification parts 251 and 252, the user what contents are stored in the recording medium 100. The user selects a reproduction target content of the N pieces of content. Information on the reproduction target content is notified to the controller 210 via the user input part 240, whereby the reproduction processor 211 of the controller 210 starts reproduction processing of the selected content (step S1). At this point, the reproduction processor 211 acquires, via the R/W processor 213, the content information stored in the recording medium 100 corresponding to the reproduction target content, and acquires the content key for reproduction from the acquired information. Further, the reproduction processor 211 performs the decoding processing and decryption processing, and outputs by operating the decoder LSI 260, encryption/decryption LSI 270, and user notification parts 251 and 252 via the HW driver 214.

When the reproduction of the reproduction target content has ended, the processing ends (step S2).

Subsequently, if the user requests information on content related to the content whose reproduction has ended via the user input part 240, the user terminal 200 obtains the information on the related content. That is, the user terminal 200 transmits, to the content management server 400 via the communication processor 230, a content ID of the content whose reproduction has ended, and requests the information on the content related to this content (step S3). The content management server 400 searches the content information DB 410 to acquire the information on the content related to the reproduction target content, and then transfers it to the user terminal 200 (step S4).

The user terminal 200 notifies the information on the related content acquired at step S4 to the user via the user notification parts 251 and 252. If no related content is stored in the recording medium 100, a notification prompting purchase of the content is provided to the user via the user notification parts 251 and 252 (step S5).

Subsequently, if the user selects the related content and requests the purchase thereof via the user input part 240, the user terminal 200 performs purchase processing of the related content. That is, the user terminal 200 transmits this related content ID to the content distribution server 500 via the communication processor 230, and requests transfer of the encrypted content file of the related content (step S6). The content distribution server 500 searches the encrypted content DB 510 to acquire the encrypted content file of the related content, and then transfers it to the user terminal 200 (step S7). The encrypted content file is stored into the recording medium 100 in the form described in FIG. 4.

Next, the purchase processor 212 of the user terminal 200 transmits the related content ID, the user ID, and the like to the accounting server 600 via the communication processor 230 and requests the purchase of the related content (step S8). The accounting server 600 performs accounting processing by registering the purchase history into the purchase history DB 620 (step S9). Then, the accounting server 600 searches the content key DB 610 to acquire the content key of the related content, and then transfers it to the user terminal 200 (step S10). The content key is stored into the recording medium 100 in the form described in FIG. 4.

The user terminal 200 reproduces the related content acquired at step S7 by decrypting it by using the content key acquired at step S10 (step S11).

As described above, in the content processing shown in FIGS. 7A and 7B, after the user requests the purchase of the related content, the encrypted related content and content key are transferred. Therefore, the larger a file size of the related content becomes, the longer waiting time imposed on the user from the determination of the purchase of the related content to the reproduction thereof becomes.

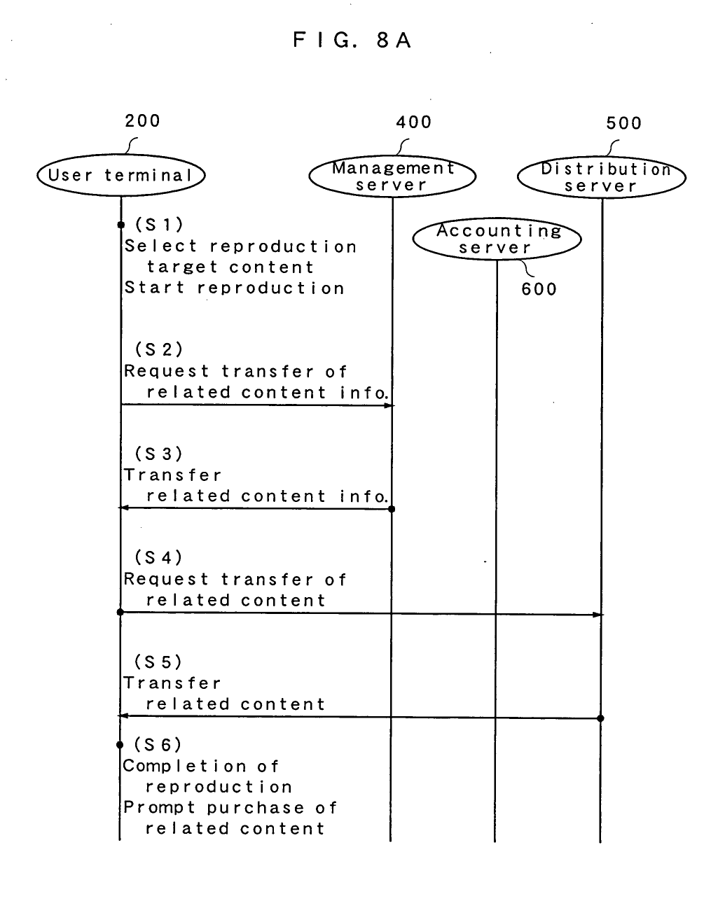

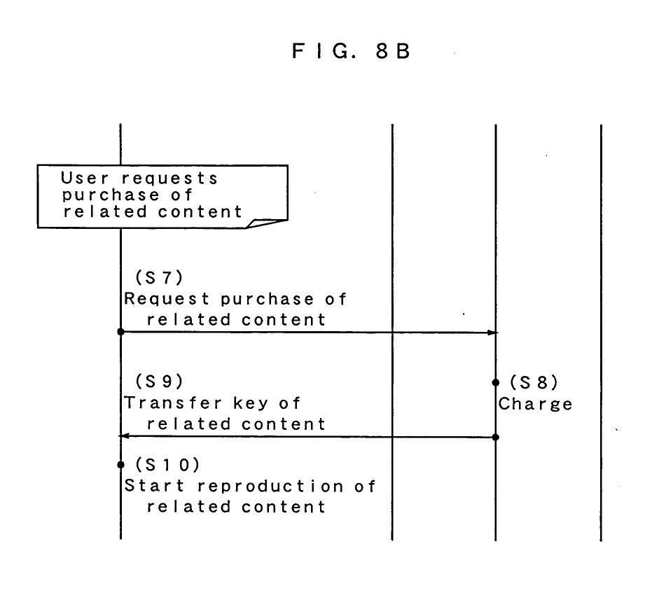

Next, referring to FIGS. 8A and 8B, operation performed by the content distribution system according to the present embodiment will be described. In the recording medium loading part 220 of the user terminal 200, the recording medium 100 is loaded, in which N pieces of content have already been stored in the form shown in FIG. 4. The user terminal 200 notifies the user what contents are stored in the recording medium 100 via the notification parts 251 and 252. The user selects one content targeted for reproduction from among N pieces of content. Information on the reproduction target content is notified to the controller 210 via the user input part 240, whereby the reproduction processor 211 of the controller 210 starts the reproduction processing of the content targeted for reproduction (step S1). At this point, the reproduction processor 211 acquires, via the R/W processor 213, the content information stored in the recording medium 100 corresponding to the reproduction target content, and acquires the content key for reproduction from the acquired information. Further, the reproduction processor 211 performs the decoding processing and decryption processing, and outputs by operating the decoder LSI 260, encryption/decryption LSI 270, and user notification parts 251 and 252 via the HW driver 214.

After the start of the reproduction, the user terminal 200 transmits, to the content management server 400 via the communication processor 230, a content ID of the reproduction target content and requests information on content related to the reproduction target content (step S2). The timing at which the information on the related content is requested may be simultaneous with the content reproduction, but in the present embodiment, this timing follows the timing information for starting acquisition of net information included in the content information of the corresponding content. Detailed examples of this timing information include: timing at which a predetermined time (for example, 3 minutes) has passed since the start of content reproduction, timing at which the reproduction of an initial part (for example, 10%) of the entire content has ended, timing at which the reproduction of an initial n frame of the content data (for example, n is 2000) has ended, and the like. Instead of constantly acquiring information from the communication network immediately after the start of reproduction, delaying the timing of information acquisition based on this timing information can reduce an excessive load on the communication network. For the address of the content management server 400, reference is to be made to a net information acquisition address in the content information.

Then, upon receiving this request, the content management server 400 searches the content information DB 410. Then the content management server 400 acquires the information on the content related to the reproduction target content and then transfers it to the user terminal 200 beforehand so as to permit judgment on whether or not the user will purchase it after reproduction (step S3).

Further, the user terminal 200 transmits the related content ID to the content distribution server 500 via the communication processor 230 and requests transfer of the encrypted content file of the related content (step S4). The address of the content distribution server 500 is referred to the net information acquisition address. The content distribution server 500 searches the encrypted content DB 510 to acquire the encrypted content file of the related content, and then transfers it to the user terminal 200 (step S5). The transferred encrypted content file is stored into the recording medium 100 in the form described in FIG. 4.

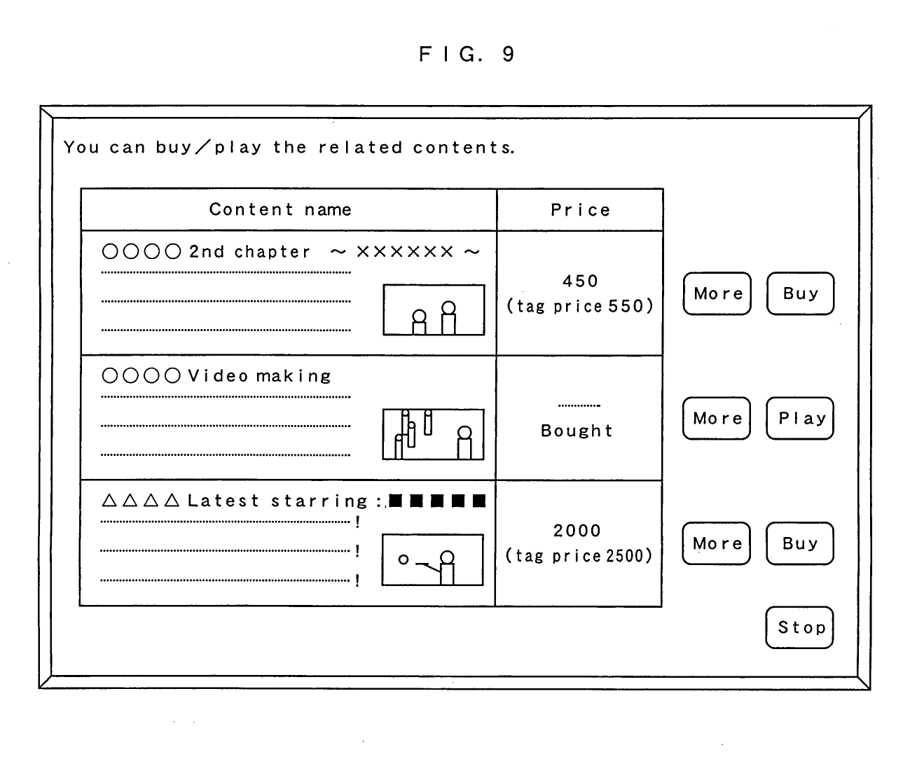

When the reproduction of the content has ended, the user terminal 200 notifies, by an image and a sound, the information on the related content acquired at step S3 to the user via the user notification parts 251 and 252. At this point, if the related content has not yet been purchased, a notification prompting the purchase of the content is also provided (step S6). FIG. 9 shows an example of display provided by the user notification part 251. In the example of FIG. 9, three pieces of information on the related content are displayed, one of which has already been purchased and the remaining two of which have not yet been purchased.

Subsequently, if the user requests purchase of any of the related contents via the user input part 240, the user terminal 200 performs purchase processing. That is, the purchase processor 212 transmits the selected related content ID, user ID, and the like to the accounting server 600 via the communication processor 230 and requests the purchase of the related content (step S7). The address of the accounting server 600 is referred to the net information acquisition address. The accounting server 600 performs the accounting processing by registering the purchase history into the purchase history DB 620 (step S8). Then, the accounting server 600 searches the content key DB 610 to acquire the content key of the related content, and then transfers it to the user terminal 200 (step S9). This content key is stored into the recording medium 100 in the form described in FIG. 4.

The user terminal 200 reproduces one of the related contents acquired at step S5 by decrypting it by using the content key acquired at step S9 (step S10). At the time when the content key is acquired in step S9, downloading the related content in step S5 may not have been completed. This happens in the case where the size of the related content is too large, or where the reproduction time of the content first reproduced is short, or for some other case. In these cases, the reproduction of the related content may be started after the downloading of this related content has been completed, or may be started while downloading this related content.

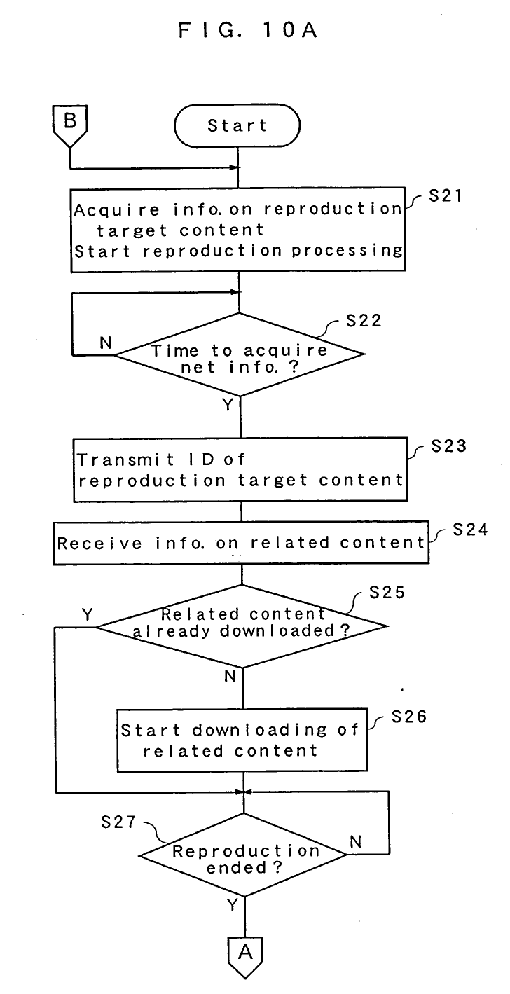

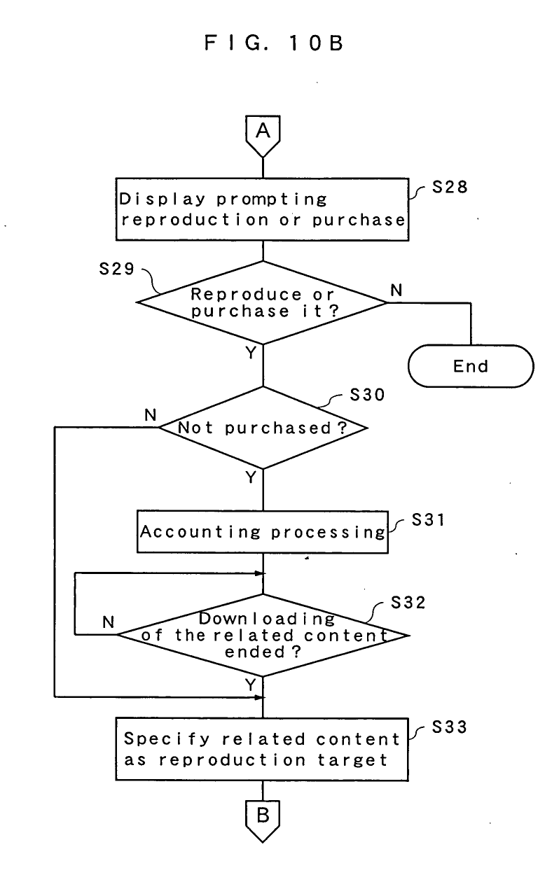

FIG. 10A and FIG. 10B show the sequence of internal processing performed by the user terminal 200 in particular in the operation of the content distribution system according to the present embodiment described above.

In step S21, the content information on the reproduction target content is acquired, and reproduction processing thereon starts. In step S22, determination whether or not it is time to acquire the net information is made. If “YES”, the processing proceeds to step S23.

In step S23, the ID of the reproduction target content is transmitted to the management server 400, and the information on the related content is received from the content management server 400 in step S24.

In step S25, determination whether or not the related content has already been downloaded (DL) is made. If “YES”, the processing proceeds to step S27. If “NO”, the processing proceeds to step S26, where downloading of the related content from the content distribution server 500 starts.

In step S27, determination whether or not the reproduction of the reproduction target content has ended is made. If “YES (Completed)”, the processing proceeds to step S28. In step S28, a display prompting the reproduction or purchase of the related content is provided. Next, in step S29, judgment whether or not the user reproduces or purchases it is made. If “YES (Reproduce or Purchase)”, the processing proceeds to step S30, while, if “NO”, the processing ends.

In step S30, the user terminal 200 determines whether or not this content has already been purchased. If it has not yet been purchased, the accounting processing is performed in step S31. If purchased, the processing proceeds to step S32 without performing the accounting processing. In step S32, judgment is made whether or not downloading of the related content has already ended. If “YES (DL ended)”, the processing proceeds to step S33, while, if “NO”, the downloading continues.

In step S33, the user terminal 200 specifies reproduced content as new reproduction target content, and then returns to step S21 to reproduce the reproduction target content.

As described above, in the content distribution system according to the present embodiment, while the user is reproducing reproduction target content, the related content is downloaded in parallel. Thus, at the time the user requests purchase of the related content, all or part of the encrypted content file of the related content has already been downloaded, thus permitting a drastic reduction in the waiting time for the user from purchase of the related content to reproduction thereof. The present invention is especially effective in the content distribution system via the communication network.

It should be noted that, although the present invention has been described based on the embodiment described above, the invention is, of course, not limited to the embodiment described above. Modifications can be made to the present invention without departing from the sprit of the present invention. Those cases described below are also included in the invention.

(1) In the present embodiment, the FAT file system is used in the search information storage region, while a different file system, such as an FAT32, a UDF (universal disc format), or the like may be used, or the size, the recording address, or the like may be managed without use of any file system.

(2) In the present embodiment, content and information thereon are stored in the form shown in FIG. 4, although this form is just one example and various other modified examples can be possible.

For example, a content information file may be divided into a plurality of files, the number of items may be increased or decreased, or the order may be switched.

In terms of protecting a copyright, it is particularly convenient to manage highly confidential information, such as the content key as a different file in some cases. For example, in a case where the recording medium 100 is the SD memory card, a possible method is to store a file storing the content key into the protected area.

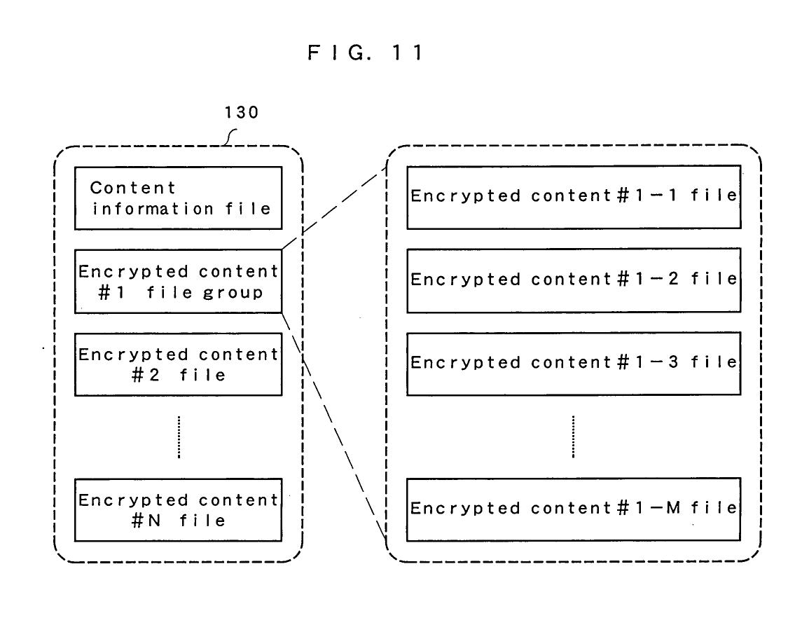

Further, in the example of FIG. 4, one content is stored as one encrypted content file onto the recording medium. However, one content may be stored in the state of being divided into a plurality of encrypted content files (#1-1) to (#1-M) as shown in the example of FIG. 11.

In a case where the related content is divided into a plurality of encrypted content files, sequentially reproducing those files whose downloading have already been completed realizes a reduction in the waiting time until start of reproduction even when the related content of a large size is downloaded.

(3) In the present embodiment, the positions (addresses) of the content management server 400, content distribution server 500, accounting server 600, and the like on the communication network 300 are to be previously stored in the net information acquisition source addresses in the content information file, however, in a case where the user terminal 200 has a method for acquiring these addresses by a different method, or in a case where fixed addresses are always guaranteed, these acquisition source addresses may not be used.

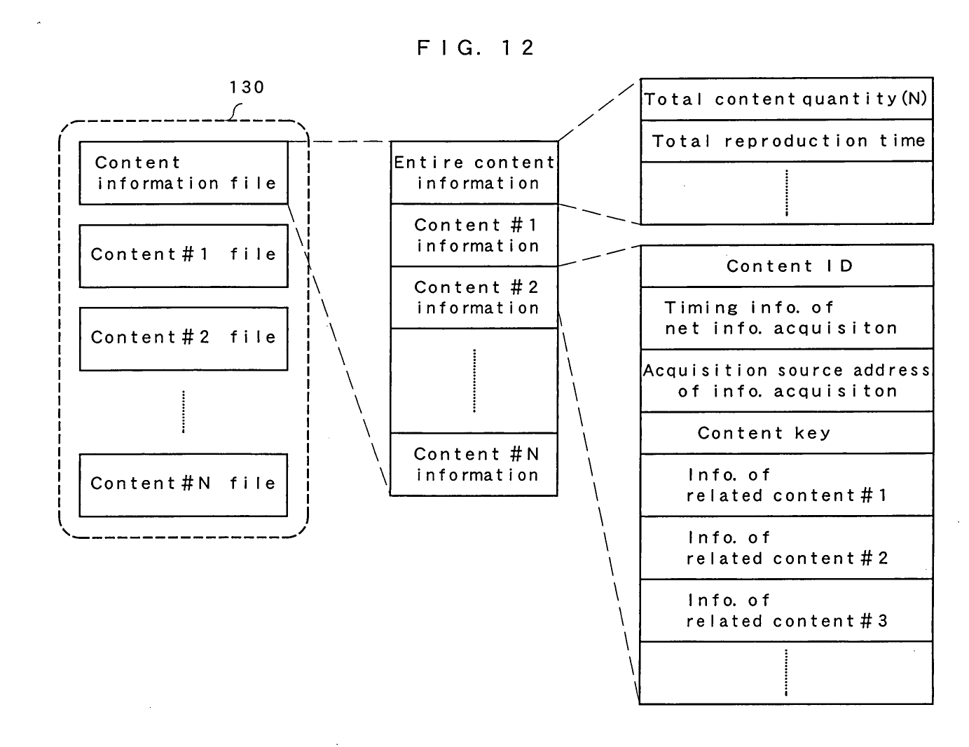

(4) In the present embodiment, information such as the related content ID and information on the related content of certain content are acquired from the content management server 400 via the communication processor 230. Alternatively, the related content ID may be stored in the content information file, or, as shown in FIG. 12, information on the related content including the ID may be stored for use. If the recording medium 100 stores the information on the related content ID, the information on the related content can be displayed even when the user terminal 200 is not connected to the communication network 300.

In this case, when the user terminal 200 is connected to the communication network 300, the information on the related content is acquired from the content management server 400 via the communication processor 230 and then this information is stored or overwritten into the recording medium 100, thereby permitting display of latest information on the related content.

(5) The present embodiment has described the case where content related thereto is downloaded and then purchased by the user when certain content is being reproduced. The related content downloaded may be immediately erased at the moment when the user decides not to purchase it, or may be erased when the related content purchased exceeds a fixed storage capacity. In this case, possible methods of selecting the related contents are given below.

(a) The related contents are selected in the chronological order of downloading dates.

(b) The related contents of the reproduced content are selected in the chronological order of reproducing dates.

(c) If there is a plurality of related contents for one reproduced content, these related contents are selected in ascending order of relevance.

(d) The related contents are selected in the order of sizes.

(e) If the related contents are referred from a plurality of reproduced contents, the related contents are selected in ascending order of the number of references.

(f) The related contents are selected in ascending order of priorities (for example, preference levels or frequencies of reproduction specified by the user) of the reproduced contents.

(g) The related contents are selected by the methods described above in combination.

(6) Further, in the present embodiment, while certain content is being reproduced, downloading of the related content starts. Instead of transferring the related content itself, only the related content information may be transferred. If so, the related content information can be displayed immediately after the reproduction of the reproduction target content has ended, as shown in FIG. 9. In this case, if the user determines to purchase the related content, transfer of this related content is requested to the content distribution server and then the transferred related content is received.

The recording medium, data processing device, and data processing system according to the present invention can reduce the waiting time during downloading operation by obtaining at least information on content related to content under reproduction, and are thus useful in various appliances and systems which require downloading of pictures, sounds, and various data.

Here, the preferred embodiment has been described, but it should be noted that various other embodiments and modified examples that can be assumed by those skilled in the art are to be included in the scope and spirit of the present invention, and such other embodiment and modified embodiments are included in claims described below.

The text of Japanese Unexamined Patent Publication No. 2005-108364 filed on Apr. 5, 2005 is hereby incorporated by reference.

What is claimed is:

1. A recording medium storing at least one content and information on said content,
wherein the information on said content comprises:
address information on a communication network required for acquiring information on related contents related to said content via the communication network; and
timing information indicating timing for starting the acquisition of said information on said related contents via the communication network.

2. A data processing device to which a recording medium storing at least one content and information on said content is connected,
wherein the data processing device comprises:
a communication processor connecting to a communication network for downloading information on related contents related to said content and the related content into said recording medium; and
a controller which controls to reproduce the content stored in said recording medium and to acquire the information on said related contents from said communication processor via said communication network before the reproduction of said content ends.

3. The data processing device according to claim 2, wherein said communication processor determines timing for acquiring information on related contents related to said content via said communication network, based on timing information for net information acquisition stored in said recording medium.

4. The data processing device according to claim 2, wherein said related contents are contents provided in series of said contents.

5. The data processing device according to claim 2, wherein said related contents are contents having at least one attribute in common with said content.

6. The data processing device according to claim 2, wherein said controller provides a notification prompting reproduction or purchase of said related contents immediately after the reproduction of the content ends.

7. The data processing device according to claim 2, wherein said related contents are encrypted contents.

8. A data processing device to which a recording medium storing at least one content and information on the content is connected,
wherein the data processing device comprises:
a communication processor connecting to a communication network for downloading related content related to said content into said recording medium; and
a controller which controls to reproduce the content stored in said recording medium and to acquire the related contents from said communication processor via said communication network before the reproduction of said content ends.

9. The data processing device according to claim 8, wherein said communication processor determines timing for acquiring said related contents via said communication network, based on net information acquisition timing information stored in said recording medium.

10. The data processing device according to claim 8, wherein said related contents are contents provided in series of said contents.

11. The data processing device according to claim 8, wherein said related contents are contents having at least one attribute in common with said content.

12. The data processing device according to claim 8, wherein said controller provides a notification prompting reproduction or purchase of said related contents immediately after the reproduction of the content ends.

13. The data processing device according to claim 8, wherein said recording medium previously stores information on said related content.

14. The data processing device according to claim 8, wherein said related contents are encrypted contents.
